(19) United States
(12) Patent Application Publication
(10) Pub. No.: US 2013/0206690 A1
(43) Pub. Date: Aug. 15, 2013

(54) Water Treatment Via Ultrafiltration

(71) Applicants: Ulrich Bauerle, Pliezhausen (DE); Joachim Georgi, Bad Kissingen (DE)

(72) Inventors: Ulrich Bauerle, Pliezhausen (DE); Joachim Georgi, Bad Kissingen (DE)

(73) Assignee: GWT GEORGI WASSERTECHNIK GMBH, Grafenrheinfeld (DE)

(21) Appl. No.: 13/369,774

(22) Filed: Feb. 9, 2012

(51) Int. Cl. C02F 1/52; C02F 1/44

(52) U.S. Cl. 210/638; 210/195.2

(57) ABSTRACT

Apparatus for purification of oil contaminated water, particularly of reservoir water from oil production, comprising a depression for receiving the contaminated water, wherein a first partial separation of oil particles and water is carried out within the depression, so that, on the one hand, the oil and, on the other hand, the water reduced in oil content are drained off from the depression, wherein the oil content-reduced water is guided from the depression to an ultrafiltration device, wherein a precipitant is added to the oil content-reduced water before introducing the oil content-reduced water into the ultrafiltration device, and wherein the oil content-reduced water in the ultrafiltration device is separated into a clearwater phase and an oil-enriched phase using a membrane made of polymers, and wherein the oil-enriched phase is guided back to the depression, and the clarification water phase is drained off.

### BACKGROUND OF THE INVENTION

The invention relates to an apparatus and a method for the purification of oil-contaminated reservoir water, particularly from oil production, in accordance with the preamble of claims 1 and 6.

In the production of oil an oil-water mixture is generally conveyed from the earth. For newly developed oil fields this mixture consists of the formation water already contained in the oil-bearing layer as well as the oil, which shall be conveyed. In older oil fields, water must be injected into the oil formation for conveying the oil/water mixture by injection wells, which are located in a certain direction from the discharging well. By the so-built-up pressure, the water flows into the oil-bearing layer towards the discharging well and thereby carries oil, which then can be extracted from the discharging well together with the injection water and possibly present formation water.

This oil/water-mixture must then be separated, in order to obtain crude oil suitable for further processing. The water content of the oil/water-mixture differs from oil field to oil field and also changes with the progressive exploitation of the oil field.

Phase separators are generally used to separate the oil/water-mixture, i.e. the oil/water-mixture is transferred into a tank, in which the lighter oil and the heavier water under the influence of gravitation can be separated, so that an oil phase is formed on the surface and the water phase (reservoir water) in the bottom tank area.

After such a separation by a gravity, however, between 500 and 1000 mg oil per litre still remain in the reservoir water. This means, on the one hand, a considerable waste of precious oil and, on the other hand, the reservoir water can not be released into the environment, due to the significant contamination with oil, but requires further reprocessing and purifying.

Currently available treatment methods and treatment devices, however, have significant disadvantages in terms of cost and processing power. In the conventional three-phase separators used in the United Arab Emirates, a residual oil content of 500 ppm of oil remains in the waste water. With such a high contamination the disposal of reservoir water is extremely problematic. The waste water is to some extend directed into specific effluent ponds, implying a significant pollution. Alternatively, the waste water is partially compressed under high pressure into porous aquifers. Although the reservoir water is initially removed, however, ground water supplies of future drinking water sources are destroyed by this practice.

In German oil fields a reduction of residual oil content of about 60 ppm is achieved via coalescence separators. However, this contamination is still too high for a direct discharge of the water reservoir, so that here the reservoir water is also delivered to a sewage treatment plant, resulting in significant extra cost.

The obvious solution, at first glance, using the contaminated reservoir water as injection water for the injection wells, in many cases fails due to the residual oil content of the water. The oil particles, when injected into the oil field, can clog pores of the oil-bearing formation and thus reduce the capacity of the oil field considerably, and, in extreme cases, result in running dry of the conveyance. Even if possible, pressing back the reservoir water into the oil field is connected with further problems. For the save storage of the contaminated water the pressing operation would require to be performed precisely within the oil carrying conductor, which is accessed by the discharging well. Such a precise feeding is hardly guaranteed. Hence, there is always a risk that fed reservoir water does not remain within the oil field, but is rather pressed into other strata and thus can lead to contamination, and, in extreme cases, to contamination of the ground aquifer.

Attempts of ultrafiltration of oil-contaminated reservoir water have been carried out repeatedly. However, the problem occurred that the membranes used have been irreversibly clogged up by the oil particles within a short time. By using ceramic membranes a back-flushing capability could be achieved, so that the membranes could be used for a longer time. However, the tool life of these special ceramic membranes between the rinsing operations is very short, and the cost of the membranes is very high. Therefore, methods employing these membranes are suitable in a very few special cases with a relatively low reservoir water volume.

It is thus the object of the invention to provide an apparatus and a method, by which the residual oil content of the reservoir water can be significantly reduced below the currently feasible values, in order to allow further use of the reservoir waters as, for instance, injection water or for the production of process steam to allow for long lead times and low maintenance intervals and carried out simultaneously at low cost. This object is achieved by the apparatus according to claim 1, and the method according to claim 6. Further advantageous embodiments are subject of the dependent claims.

### SUMMARY OF THE INVENTION

An apparatus for the purification of oil-contaminated reservoir water, particularly deposit water, has a depression for receiving the reservoir water. This reservoir water usually comes from a phase separator, in which a separation of the oil/water mixtures from the conveyance has already taken place, and has typically an oil content of 500 to 1000 mg/l. Also possible are deviating oil contents, which may extend from 200 to 5000 mg/l.

A variety of devices to be used as depressions come into consideration. Generally, a separation of the reservoir water into recovered free oil and a water phase with lower oil content should already take place within the depression.

The context of the invention offers the possibility to use, for example, a settling basin, a pool, or a tank as depression, in which further gravitation separation might be carried out. Additionally, for example, lamella clarifiers, inclined-tube clarifiers, quick clarifiers or coalescence precipitators might be used. Particularly advantageous for use as depression can be a pressure-relaxation flotation. Here, air or gas bubbles are introduced into the reservoir water, leading to a separation of oil and water. Three phases are then formed in the depression, the oily phase, which can be removed, at the surface, an aqueous phase with reduced residual oil content and on the bottom of the depression possibly carried solid materials, which are deposited as a slurry being removed in certain time intervals.

The aqueous phase with reduced residual oil content can then be removed from the depression and be fed to the subsequent ultrafiltration. In support of the ultrafiltration, the reservoir water with reduced residual oil content is dosed with a flocculation agent or coagulant before being fed to an ultrafiltration.

As a membrane being used for the ultrafiltration step hollow fiber membranes may be used, which can be manufactured cost-effectively and which provide a large membrane surface area requiring a small space. These membranes are designed to let pass only the water molecules through the membrane pores of flowing water, whereas the larger hydrocarbons, of which the oil consists, are detained.

The clear water can then be removed from the ultrafiltration step. This clear water has only a portion of 2-4 mg per litre of dissolved hydrocarbons. Solids are completely precipitated. Thus, the clear water is pure enough to be used as injection water for the injection wells without the risk of clogging the pore spaces of the oil field. Furthermore, the clear water removed from the ultrafiltration is also disinfected. This has a great importance for the suitability as injection water, since bacteria decompose the stored crude oil in the oil field and could thus destroy the oil field. Even if no use is made as injection water, the further processing, such as in a sewage treatment plant, is greatly simplified by the much-reduced residual oil content and can be carried out at lower cost. After further treatment for desalination by, for example, reversed osmosis, the clear water can be used for other purposes, such as boiler feed water in petroleum processing.

Because of the clear water being removed from the ultrafiltration step, the residual oil in the remaining reservoir water phase will be again concentrated. This reservoir water phase with concentrated residual oil content is therefore re-supplied into the depression, so that a separation of a concentrated reservoir water phase into an oil containing phase and a water containing phase can be carried out again in the depression.

### BRIEF DESCRIPTION OF THE SEVERAL VIEWS OF THE DRAWINGS

Further features, combinations of features, advantages, and characteristics of the invention are illustrated by the following description of a preferred embodiment and in the drawings. These show:

FIG. 1 A schematic representation of the oil conveyance in an oil field and the water processing during oil production;

FIG. 2 a schematic representation of a water treatment plant in accordance with the present invention.

### DETAILED DESCRIPTION OF THE INVENTION

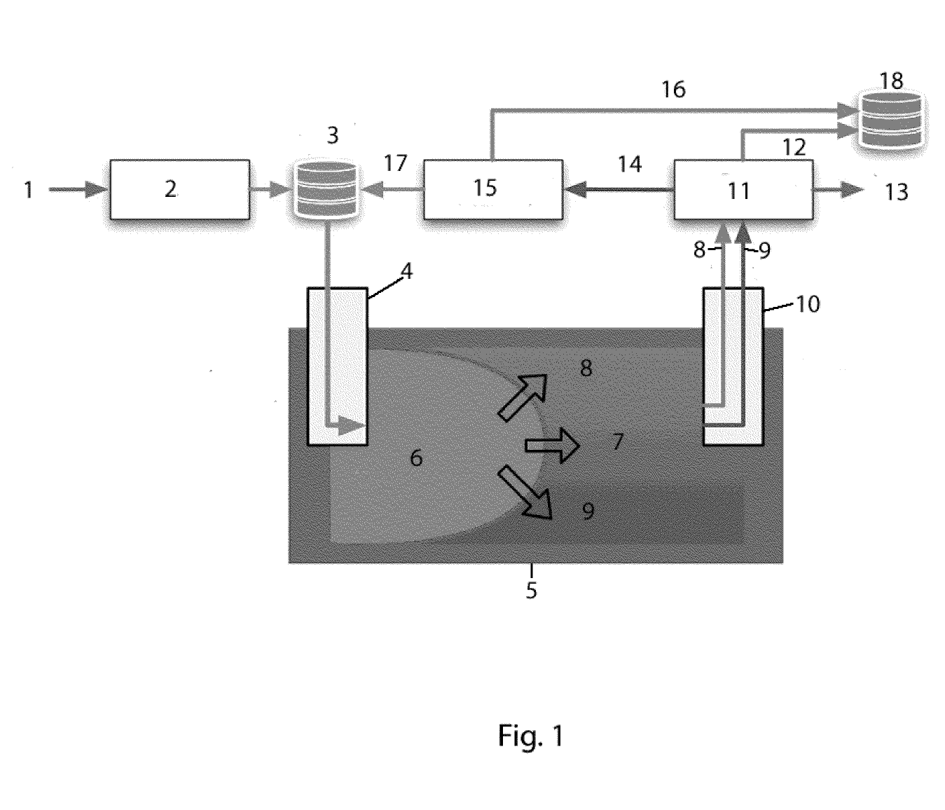

FIG. 1 shows an external water source 1 (for example, either an underground aquifer or sea water), from which water has been taken out and which is pumped into the oil field 5 after conditioning in a processing plant 2 (e.g. sea water desalination) via an injection well 4. In order to cover fluctuations, the injection water may be previously stored in a tank 3. A water bank 6 is being formed in the oil field by the injected water, by which the oil bank 7 is pushed in the direction of the conveyer well 10. The oil bank 7 is composed of a portion of oil 8 and a portion of formation water 9. The oil 8 resides in the elevated part of the oil bank because of its density, while the formation water is primarily stored in the lower areas.

From the conveyance well 10 leaks a mixture of oil 8 and formation water 9. This is subjected in the first treatment step 11 to a separation. The separation usually takes place in phase separators; it is therefore a gravity separation process. The oil from a treatment step 11 is stored via line 12 into a tank 18 until it is removed for further processing. In systems of the prior art, the contaminated formation water is pumped into an aquifer or in disposal ponds (symbolised by the arrow 13 in the figure).

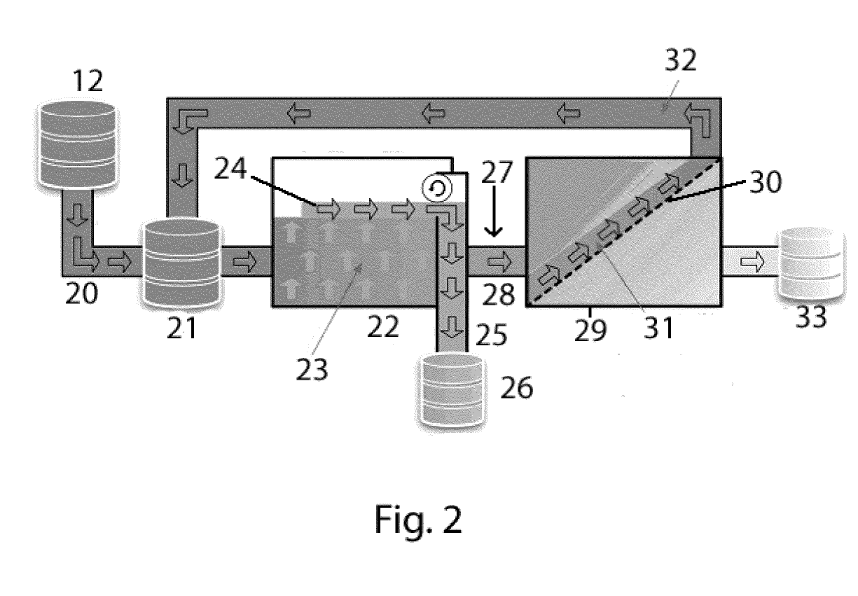

Here the present invention joins in. The oil-containing reservoir water (formation water or injection water) is passed through line 14 to the water treatment plant 15. There, the processing and separation of oil and water takes place (see FIG. 2). The so-obtained additional oil can also be transferred via line 16 into tank 13 and thereby increases the overall yield of oil production. The purified reservoir water can be transferred via line 17 into the injection water tank 3 and be used for injection into the oil field. This eliminates the need for conveying and processing injection water with costly efforts and concurrently avoids environmental pollution caused by contaminated reservoir water from the oil production process.

FIG. 2 shows the water treatment system 15 in detail. The contaminated reservoir water is fed into feeding tank 21 via line 20 from the gravity separation tank 12 for oil recovery. From this tank the contaminated reservoir water is fed into the depression 22. In the present embodiment a dissolved air flotation (DAF) with air bubbles is employed as depression. It is also possible to use gas flotation or other separation methods, such as coalescence precipitators. In the pressure-relaxation flotation finely distributed air bubbles are injected into the reservoir water, which rise up in direction of 23 and thereby “carry” the oil particles due to different surface wetting, so that an oil phase 24 is formed on the surface. This oil phase 24 can be decanted or being removed or discharged otherwise and is discharged through line 25 into a tank 26 for the recovered oil. From there a redirection to the main oil tank 18 may occur (not shown).

An existing separator or phase separator can be used as a depression with appropriate equipment of the conveyer systems, provided that these already achieve a sufficient reduction of oil content in the reservoir water. This is especially the case for conveyer systems that are already equipped with a coalescence precipitators or a flotation separation.

The reservoir water reduced in oil content is discharged through line 28 and receives the addition of a flocculation or precipitation agent at dose 27. Preferably, iron-III-chloride is added as precipitation agent with a concentration of 0.1 mg/l and 20 mg/l, preferably between 0.5 mg/l and 10 mg/l, more preferably between 1 mg/l and 5 mg/l, but other precipitation agents, in general, are also possible. After dosing the precipitation agent the reservoir water is fed into the concentration/advance treatment unit 29. This concentration/advance treatment unit 29 has an ultrafiltration membrane 30. This ultrafiltration membrane 30 consists of a polymer membrane and is capable to retain particles of a size larger than 0.02 μm. Thus, all free oil particles, solids and germs are reliably retained in the reservoir water.

The ultrafiltration membrane 30 is operated in a cross-flow-operation, i.e. the reservoir water is being passed along the membrane with a relatively high velocity. Alternatively, dead-end operation is possible. In order to achieve high efficiency of the filtration, it is of advantage in cross-flow-operation, when the reservoir water is repeatedly guided past the membrane using a recirculation procedure. When the reservoir water is running along the membrane, water molecules pass through the membrane and are subsequently discharged. This water (permeate) is free of free oil, solids, and germs, and merely contains minor residues of dissolved hydrocarbons. The permeate can then be discharged into the clear water tank 33 and subsequently be used as injection water, or, where appropriate, after further processing be used for production of process steam or be properly disposed. The remaining reservoir water 31 is concentrated by the discharge of the permeate. When reaching an accordant concentration, the concentrated reservoir water is guided back into the feeding tank 21 and from there is fed again in the depression 22, where the concentrated oil can be recovered.

1. Apparatus (15) for purification of oil contaminated water, particularly of reservoir water from oil production, comprising a depression (22) for receiving the contaminated water, wherein a first partial separation of oil particles and water is carried out within the depression (22), so that, on the one hand, the oil (24, 25) and, on the other hand, the water reduced in oil content (28) are drained off from the depression, characterized in that the oil content-reduced water is guided from the depression (22) to an ultrafiltration device (29), wherein a precipitant (27) is added to the oil content-reduced water before introducing the oil content-reduced water into the ultrafiltration device (29), and wherein the oil content-reduced water in the ultrafiltration device (29) is separated into a clearwater phase (33) and an oil-enriched phase (31) using a membrane (30) made of polymers, and wherein the oil-enriched phase (31) is guided back to the depression (22), and the clarification water phase (33) is drained off.

2. Apparatus (15) according to claim 1, characterized in that the depression (22) is formed as a clarification basin, tank, pool, lamella clarifier, inclined-tube clarifier, quick clarifier, or as a pressure-relaxation flotation.

3. Apparatus (15) according to claim 1, characterized in that the precipitant (27) consists of iron-III-chloride.

4. Apparatus (15) according to claim 3, characterized in that the iron-III-chloride is added with a concentration of 0.1 mg/l and 20 mg/l.

5. Apparatus (15) according to claim 4, characterized in that the oil content-reduced water is repeatedly guided past to the membrane using a drift produced in the ultrafiltration device (29).

6. Method for the purification of oil-contaminated water, particularly reservoir water from oil production, characterized by the following steps:
a) Feeding the contaminated water in a depression (22), wherein a first partial separation of the contaminated water into oil components (24, 25) and oil content-reduced water (28) is carried out;
b) Draining off the oil content-reduced water (28) from the depression (22);
c) Adding a precipitant (27) to the oil content-reduced water (28);
d) Introducing the oil content-reduced water (28) into an ultrafiltration device (29) with a membrane (30) made of polymers for ultrafiltration;
e) Separating the oil content-reduced water (28) using the membrane (30) into a oil-enriched phase (31) and a clearwater phase (33);
f) Draining off the clarification water phase (33) and reverting the oil-enriched phase (32) into the depression (22).

7. Method according to claim 6, characterized in that the depression (22) is formed as a clarification basin, tank, pool, lamella clarifier, inclined-tube clarifier, quick clarifier, or as pressure-relaxation flotation.

8. Method according to claim 6, characterized in that the precipitant (27) consists of iron-III-chloride.

9. Method according to claim 8, characterized in that the iron-III-chloride is added with a concentration between 0.1 mg/l and 20 mg/l.

10. Method according to claim 9, characterized in that a drift is produced within the ultrafiltration device (29), by which the oil content-reduced water (28) is repeatedly guided past to the membrane (30).

11. Method according to claim 8, characterized in that the iron-III-chloride is added with a concentration between 0.5 mg/l and 10 mg/l.

12. Method according to claim 11, characterized in that a drift is produced within the ultrafiltration device (29), by which the oil content-reduced water (28) is repeatedly guided past to the membrane (30).

13. Method according to claim 8, characterized in that the iron-III-chloride is added with a concentration between 1 mg/l and 5 mg/l.

14. Method according to claim 13, characterized in that a drift is produced within the ultrafiltration device (29), by which the oil content-reduced water (28) is repeatedly guided past to the membrane (30).
